(19) United States
(12) Patent Application Publication
(10) Pub. No.: US 2017/0328705 A1
(43) Pub. Date: Nov. 16, 2017

(54) HOLDING APPARATUS, MEASUREMENT APPARATUS, AND ARTICLE MANUFACTURING METHOD

(71) Applicant: CANON KABUSHIKI KAISHA, Tokyo (JP)

(72) Inventor: Satoshi Kubo, Utsunomiya-shi (JP)

(21) Appl. No.: 15/589,234

(22) Filed: May 8, 2017

(30) Foreign Application Priority Data
May 11, 2016 (JP) 2016-095182

(51) Int. Cl. G01B 11/25; H04N 5/225; G06T 7/00; G06T 7/521

(52) U.S. Cl. CPC G01B 11/254; H04N 5/2254; G06T 7/0004; G06T 7/521; G06T 2207/30164

(57) ABSTRACT

There is provided a holding apparatus for holding an optical element, the apparatus comprising: a positioning member configured to position the optical element; and an elastic member configured to apply a biasing force to the optical element toward the positioning member, wherein the positioning member and the elastic member are configured such that a difference between a linear expansion amount of the elastic member and a linear expansion amount of the optical element in a direction crossing a direction of the biasing force is not greater than a threshold.

### BACKGROUND OF THE INVENTION

### Field of the Invention

The present disclosure relates to a holding apparatus, a measurement apparatus, and an article manufacturing method.

### Description of the Related Art

As an apparatus for measuring (determining) a position and an orientation of an object, an apparatus using a pattern projection method is known. The pattern projection method obtains distance information about a plurality of points on an object according to the principle of triangulation, based on an image obtained by projecting a pattern to the object and imaging the object to which the pattern is projected.

The pattern to be projected is generated by, for example, illuminating an element having a function of spatially controlling transmittance or reflectance of light using an illumination optical system. The generated pattern is projected to the object through a projection optical system. The projected pattern can be changed if positional relationships between the illumination optical system, the element and the projection optical system change due to the influence of an environmental temperature. An illumination device in Japanese Patent Laid-Open No. 2003-161701 holds a rod lens by pressing the rod lens against a contact portion by using a spring member.

In a holding apparatus disclosed in Japanese Patent Laid-Open No. 2003-161701, a direction in which a rod lens thermally expands and a direction in which a spring member presses a rod lens do not match. Therefore, in this holding apparatus, the reproducibility of the position of the rod lens can be decreased by a frictional force applied therebetween if a temperature change causes the rod lens and the spring member to be expanded or contracted.

### SUMMARY OF THE INVENTION

The present disclosure provides, for example, holding apparatus advantageous in producibility of a position of an object held thereby.

According to an aspect of the present disclosure, a holding apparatus for holding an optical element is provided, the apparatus comprising: a positioning member configured to position the optical element; and an elastic member configured to apply a biasing force to the optical element toward the positioning member, wherein the positioning member and the elastic member are configured such that a difference between a linear expansion amount of the elastic member and a linear expansion amount of the optical element in a direction crossing a direction of the biasing force is not greater than a threshold

Further features of the present disclosure will become apparent from the following description of exemplary embodiments with reference to the attached drawings.

### BRIEF DESCRIPTION OF THE DRAWINGS

FIG. 1 shows a measurement apparatus using a holding apparatus according to a first embodiment.

FIG. 2 shows a configuration of a holding apparatus for holding a pattern generating unit.

FIG. 3 shows a configuration of a holding apparatus according to a second embodiment.

FIG. 4 shows a configuration of a holding apparatus according to a third embodiment.

FIG. 5 shows a configuration of a holding apparatus according to a fourth embodiment.

FIG. 6 shows a configuration of a holding apparatus according to a fifth embodiment.

FIG. 7 shows a gripping device provided with a measurement apparatus including a holding apparatus.

### DESCRIPTION OF THE EMBODIMENTS

Hereinafter, embodiments of the present disclosure will be described with reference to the drawings.

### First Embodiment

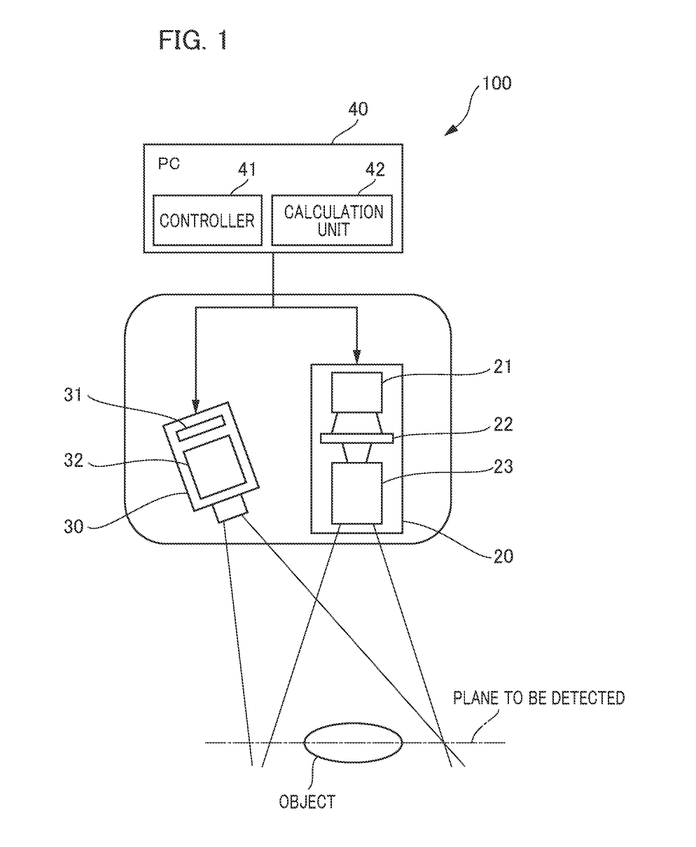

FIG. 1 shows a measurement apparatus using a holding apparatus according to a first embodiment of the present disclosure. A measurement apparatus 100 measures a shape (for example, a 3D shape, a 2D shape, a position and an orientation) of an object to be measured (object) located on a plane to be detected using a pattern projection method. As shown in FIG. 1, the measurement apparatus 100 has a projection unit 20, an imaging unit 30, and a processing unit 40.

The projection unit 20 that includes, for example, a light source unit 21, a pattern generating unit 22, and a projection optical system 23, projects a predetermined pattern to the object to be measured. The light source unit 21 uniformly illuminates a pattern generated by the pattern generating unit 22 with light emitted from a light source (for example, Koehler illumination). The pattern generating unit 22 generates a pattern (pattern light), and the generated pattern is projected to the object to be measured. In the present embodiment, a digital micromirror device (DMD) capable of generating an arbitrary pattern is used. In addition, a liquid crystal on silicon (LCOS), or a mask on which a pattern is formed by chrome-plating a glass substrate, can be used. The projection optical system 23 is an optical system that projects the pattern generated by the pattern generating unit 22 to the object to be measured.

The imaging unit 30 that includes, for example, an imaging element 31 and an imaging optical system 32, images the object to be measured and captures an image. The imaging optical system 32 is an image forming optical system for forming an image of the pattern projected to the object to be measured, on the imaging element 31. The imaging element 31 is an image sensor including a plurality of pixels for imaging the object to be measured to which the pattern is projected. For example, a CMOS sensor, a CCD sensor can be used as the imaging element 31.

The processing unit 40 obtains a shape of the object to be measured based on the image captured by the imaging unit 30. The processing unit 40 includes a controller 41 and a calculation unit 42. The controller 41 controls operations of the projection unit 20 and the imaging unit 30, specifically, projection of the pattern to the object to be measured, imaging of the object to be measured to which a pattern is projected, and the like. The calculation unit 42 finds a luminance distribution from the captured image and calculates distance information. The luminance distribution may be found by the imaging unit 30. As a calculation method, for example, a spatial encoding method is used.

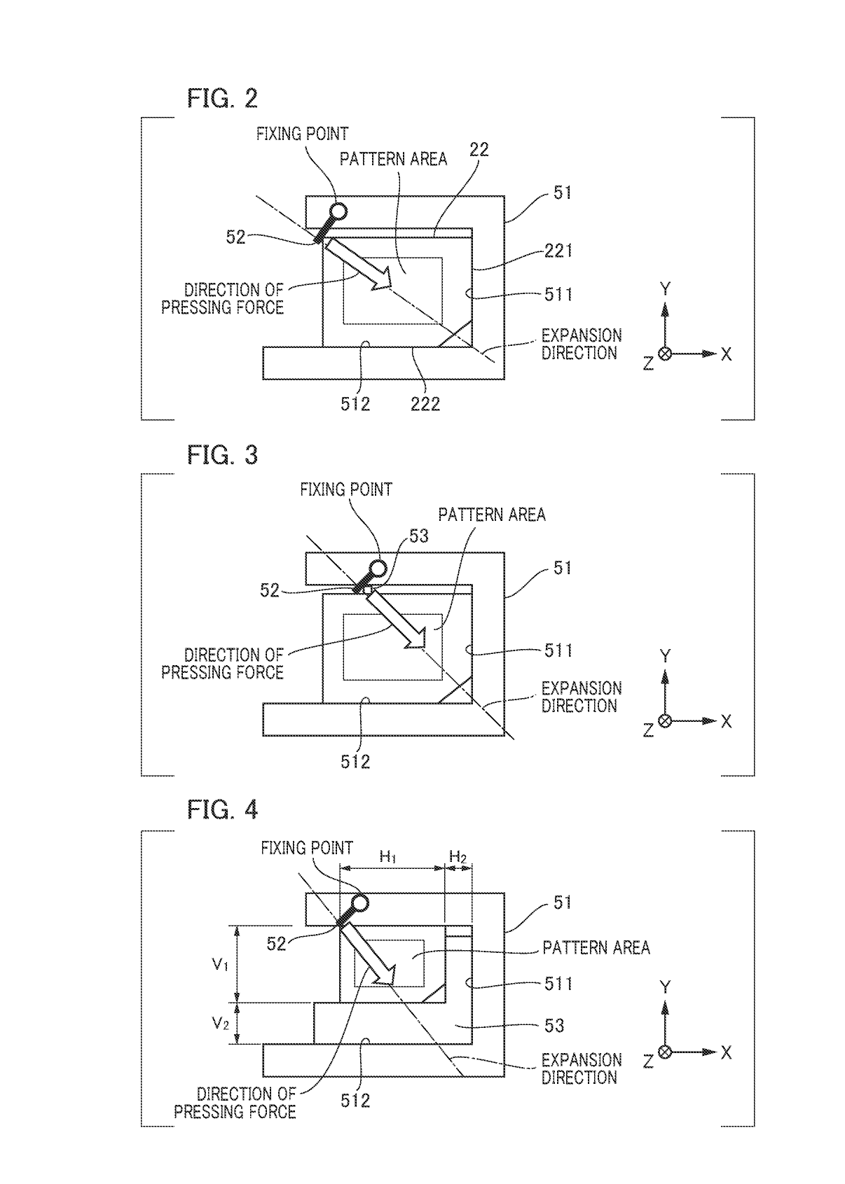

FIG. 2 shows a configuration of a holding apparatus for holding the pattern generating unit (optical element) 22. In the present embodiment, the pattern generating unit 22 having a shape such as a thin rectangular parallelepiped (thin cuboid) is used. A pattern area is provided at the center. In the projection unit 20, a holding apparatus 50 is disposed, such that the pattern generating unit 22, the light source unit 21 and the projection optical system 23 have a predetermined positional relationship. The holding apparatus 50 has a fixing member (positioning member) 51 and an elastic member 52 and is integrated with a basic structure of the measurement apparatus 100 through screw fastening. The fixing member 51 has a holding surface 511 on which a side surface 221 of the pattern generating unit 22 abuts and a holding surface 512 on which a side surface 222 of the pattern generating unit 22 abuts. In FIGS. 2 to 6, an X-axis is defined as a direction parallel to the holding surface 512, a Y-axis is defined as a direction parallel to the holding surface 511, and a Z-axis is defined as a direction perpendicular to the X-Y plane.

The elastic member 52 is screw-fastened to the fixing member 51 at a fixing point, and generates a pressing force (a biasing force) corresponding to an amount of deformation between the fixing point and a point (acting point) where the elastic member 52 contacts with the pattern generating unit 22. In the present embodiment, a plate spring is used as the elastic member 52. The rigidity of the plate spring in a direction orthogonal to a direction of the biasing force is greater than the biasing force. The elastic member 52 presses the pattern generating unit 22 from, for example, a point (the corner of the pattern generating unit 22) at which two side surfaces orthogonal to the optical axis of the pattern generating unit 22 intersect so that the side surface 221 abuts on the holding surface 511, and the side surface 222 abuts on the holding surface 512. This configuration causes the holding apparatus 50 to stably hold the pattern generating unit 22 with respect to an external force.

The fixing member 51 and the elastic member 52 are formed of, for example, aluminum, in consideration of costs and processability. The pattern generating unit 22 is formed of a nonmetal, for example, alumina ceramic. Since these have different linear expansion rates, there is a difference in linear expansion amounts therebetween. Since the side surfaces 221 and 222 are pressed against the holding surfaces 511 and 512 respectively, a point (acting point, a point on the pattern generating unit 22 where the biasing force acts) where the elastic member 52 contacts with the pattern generating unit 22 may be moved due to a temperature change. In a case where the acting point shifts in a direction crossing the pressing force (for example, a direction orthogonal to the pressing force), even if the amount of a positional shift is small, a large frictional force is generated. Then, if the frictional force exceeds a static limit, slippage occurs.

Therefore, the present embodiment has a configuration such that a direction in which the acting point shifts coincides with a direction of the pressing force of the elastic member 52. A movement direction of the acting point is uniquely determined from a distance between the acting point before thermal expansion and the holding surface 511, a distance between the acting point before thermal expansion and the holding surface 512, and a linear expansion rate of the members through calculation. In addition, if there is a difference between thermal expansion rates (linear expansion rates) of the elastic member 52 and the fixing member 51, a position of a fixing point at which the elastic member 52 is fixed is determined such that the difference is not greater than a predetermined threshold, based on the thermal expansion rates.

A description will be given of an accuracy when the direction of the pressing force of the elastic member 52 coincides with the direction in which the acting point shifts (a direction of linear expansion). For example, a case is assumed where both the fixing member 51 and the elastic member 52 are formed of aluminum, and an amount of movement of the acting point when the external environmental temperature changes is δs [μm]. If the direction of the pressing force shifts by θ [deg] with respect to the movement direction of the acting point, a shift (a difference in linear expansion amounts) G [μm] in the direction orthogonal to a pressing force at a position of the acting point is G=δs×sin θ. Here, while the shift in the orthogonal direction is considered for simplicity, the present disclosure is not limited thereto, and a shift in a crossing direction may also be similarly considered. In addition, in a case where the pressing force is F [N] and the coefficient of friction of the acting point is μ, the force of the static limit is μ×F. In this case, when a spring rigidity of the elastic member 52 in the direction orthogonal to the pressing force is K [N], the frictional force is K×G. Therefore, if K×G≦μ×F is satisfied, the frictional force does not exceed the static limit, and thus, no slippage occurs.

Since δs is about 20 μm, G is 1 μm or less, if θ is 3 deg or less. If F is 5 [N], K is 2×10⁶ [N/m], and p is 0.5, K×G=2 [N], μ×F=2.5 [N], and K×G≦μ×F. Since the frictional force does not exceed the static limit, no slippage occurs. Also, if the above values are assigned to K, μ and F of K×G≦μ×F, G≦1.25 μm and this is a threshold. The fixing member 51 and the elastic member 52 are configured such that G is not greater than the threshold.

In such a configuration, even if the temperature changes, the acting point moves only in the direction of the pressing force, and the occurrence of slippage can be prevented. The movement direction of the acting point coincides with a main deformation direction of the elastic member 52, and the main deformation of the elastic member 52 is absorbed due to elastic deformation of a spring. In addition, before and after the temperature changes, it is possible to prevent the position of the pattern generating unit 22 from being changed, and a holding accuracy (reproducibility of a position of an object to be held) is maintained.

As described above, the holding apparatus of the present embodiment can obtain a predetermined holding accuracy, since it has a configuration in which the direction of the pressing force applied to the pattern generating unit 22 by the elastic member 52 coincides with the direction of linear expansion of the pattern generating unit 22. According to the present embodiment, a holding apparatus which is advantageous in the reproducibility of the position of the object to be held can be provided.

### Second Embodiment

FIG. 3 shows a configuration of a holding apparatus according to the present embodiment. In the present embodiment, an adjusting member 53 for adjusting the position of the acting point is disposed between the elastic member 52 and the pattern generating unit 22. The adjusting member 53 is fixed at a desired position for the pattern generating unit 22 through adhesion or the like. The elastic member 52 applies the pressing force in the expansion direction of the pattern generating unit 22 using the corner of the adjusting member 53 as the acting point in the same manner as in the first embodiment.

The direction of the pressing force is determined based on a distance between the acting point and the holding surface and thermal expansion rates (linear expansion rates) of the members. If the position of the acting point is changed, the direction of the appropriate pressing force is changed. The direction of the pressing force is a direction of a force obtained by combining a force when the side surface 221 is pressed and a force when the side surface 222 is pressed. That is, a force when each side surface is pressed can be changed by changing the direction of the pressing force. If a magnitude (acceleration) of an external force applied to the measurement apparatus 100 is biased according to a direction, it is necessary to increase the pressing force in a direction in which the external force is large. For example, if the acceleration in the direction orthogonal to the holding surface 512 is greater than that in the direction orthogonal to the holding surface 511, the force applied to the holding surface 512 should be greater than the force applied to the holding surface 511. This can be implemented by moving the fixing position of the adjusting member 53 close to the holding surface 511. The position of the adjusting member 53 is close to the holding surface 511, the thermal expansion amount in the X direction is smaller than the thermal expansion amount in the Y direction, and thus, a component in the Y direction of the appropriate pressing force is greater than a component in the X direction. That is, the force applied to the holding surface 512 can be set to be greater than the force applied to the holding surface 511. As described above, the holding apparatus of the present embodiment can handle a case in which a bias occurs in an external force applied to the measurement apparatus 100 according to the direction.

### Third Embodiment

FIG. 4 shows a configuration of a holding apparatus according to the present embodiment. In the present embodiment, the adjusting member 53 is disposed between the pattern generating unit 22 and the fixing member 51. Since the pressing force of the elastic member 52 is used, it is not necessary to fix the adjusting member 53 to the pattern generating unit 22 through adhesion or the like. In the configuration of the present embodiment, the direction of the pressing force is uniquely obtained through calculation in consideration of the thermal expansion rate of the adjusting member 53.

For example, a case is assumed where the temperature change is ΔT, the linear expansion rate of the pattern generating unit 22 is α, the linear expansion rate of the adjusting member 53 is β, and in the X direction, the length of the pattern generating unit 22 from the acting point to a surface with which the adjusting member 53 contacts is H₁ and the length of the adjusting member 53 is H₂. In this case, an amount of relative movement of the acting point in the X direction with respect to the holding surface 511 is ΔT×α×H₁+ΔT×β×H₂. In addition, in the Y direction, V₁ is defined as the length of the pattern generating unit 22 from the acting point to the holding surface 512, and Vₛ is defined as the length of the adjusting member 53. The amount of relative movement of the acting point in the Y direction with respect to the holding surface 512 is ΔT×α×V₁+ΔT×β×V₂. That is, the acting point relatively moves by ΔT×α×H₁+ΔT×β×H₂ in the X direction and ΔT×α×V₁+ΔT×β×V₂ in the Y direction due to the temperature change. Sizes V₂ and H₂ of the adjusting member 53 are appropriately selected so that the movement direction of the acting point obtained by combining the amount of movement in the X direction and the amount of movement in the Y direction is a desired direction. Further, even if a bias occurs in an external force applied to a main body of the measurement apparatus 100 according to the direction, it is possible to respond to the occurrence of the bias by adjusting sizes V₂ and H₂ of the adjusting member 53. According to the present embodiment as well as the aforementioned embodiments, a holding apparatus which is advantageous in a holding accuracy can be provided.

### Fourth Embodiment

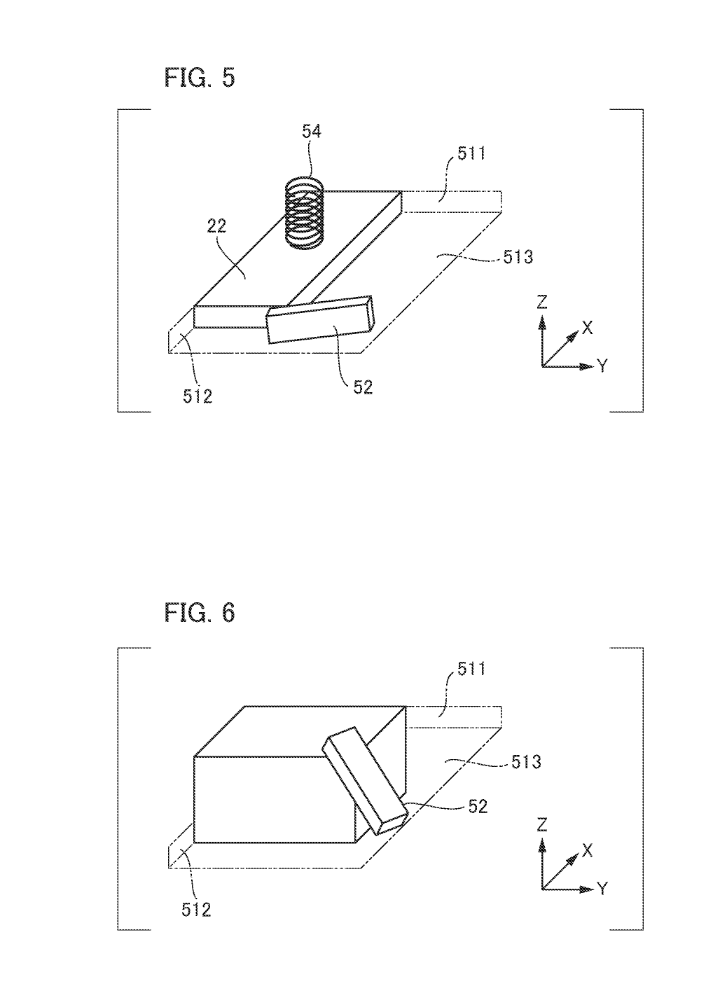

FIG. 5 shows a configuration of a holding apparatus according to the present embodiment. The fixing member 51 of the present embodiment further includes a holding surface 513 with which the front surface of the pattern generating unit 22 contacts and an elastic member 54 for pressing the rear surface of the pattern generating unit 22 to press the front surface against the holding surface 513. On the rear surface of the pattern generating unit 22, there is a large element disposition space. As the elastic member 54, an element larger than the elastic member 52 can be selected. For example, a spring having a low rigidity in a direction perpendicular to a pressing direction, such as a coil spring (a compression spring) or the like may be used. A direction of the pressing force of the elastic member 54 can be uniquely obtained through calculation in the same manner as in the direction of the pressing force of the elastic member 52. According to the present embodiment, it is possible to respond to deformation in the optical axis direction of the pattern generating unit 22, and thus, a holding apparatus which is advantageous in the reproducibility of the position of the object to be held can be provided.

### Fifth Embodiment

FIG. 6 shows a configuration of a holding apparatus according to the present embodiment. In the present embodiment, a target to be held has a larger size in the Z direction than that of the aforementioned embodiment. Even in such a case, the target to be held can be held by for example, the elastic member 52 applying a biasing force using the corner of the target to be held as an acting point. Other polyhedrons such as a prism can be held. The direction of the pressing force is calculated in the same manner as in the aforementioned embodiment. The biasing force may be applied by using the adjusting member 53. The target to be held that has a shape as in the present embodiment can be held with an appropriate holding accuracy.

Also, since the plate spring is assumed as the elastic member 52 in the above description, a relationship in which a surface of the elastic member 52 or the adjusting member 53 contacts with the corner (point) of the pattern generating unit 22 is established at the acting point of the pressing force. However, the opposite relation may be established. That is, a relationship in which the surface of the pattern generating unit 22 contacts with the corner of the elastic member 52 may be established.

In addition, the corner of the pattern generating unit 22 may be chamfered or rounded as long as the friction generated due to a difference in thermal expansion between the pattern generating unit 22 and the elastic member 52 has no influence. However, it is desirable that the processed surface is perpendicular to the direction of the pressing force. In the aforementioned embodiment, the elastic member 52 and the fixing member 51 formed of aluminum are used. However, as long as a distance between a fixing point at the fixing member 51 of the elastic member 52 and the acting point of the elastic member 52 is sufficiently short and the influence due to the difference between thermal expansions of the elastic member 52 and the fixing member 51 is small, it is not necessary to use the same materials and a material having a similar linear expansion rate may be used. (Embodiment of Article Manufacturing Method)

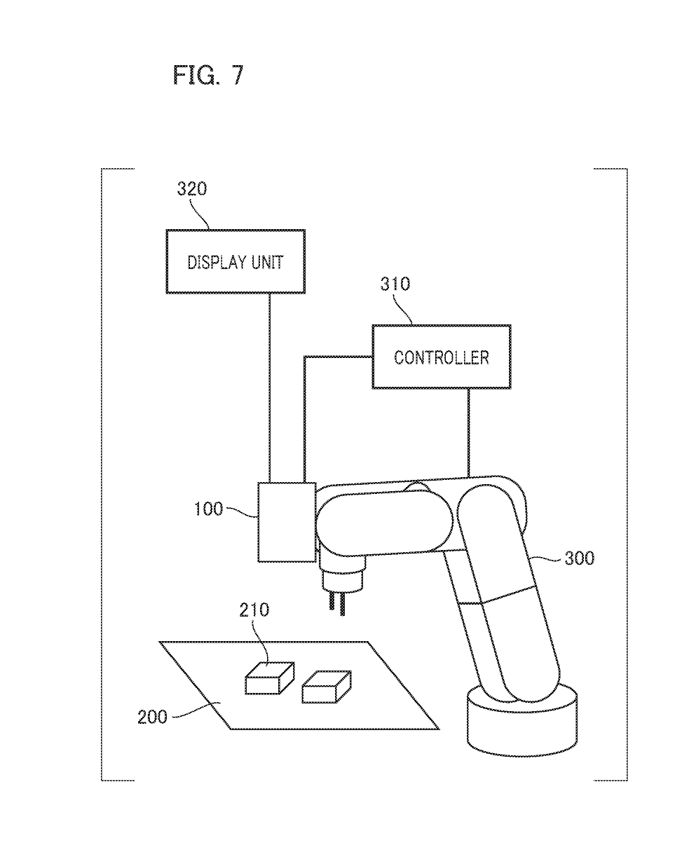

The measurement apparatus including the above-described holding apparatus may be used while being supported by any support member. In the present embodiment, a description will be given of an example of a control system that is used while equipped in a robot arm (gripping device, holding device) 300 as shown in FIG. 7. The measuring apparatus 100 projects a pattern light onto an object to be detected 210, which is located on a supporting base 200, and images the object to be detected 210 to obtain the captured image. Sequentially, a controller of the measuring apparatus 100 or a controller 310 that has acquired image data from the controller of the measuring apparatus 100 finds a position and an orientation of the object to be detected 210, and then the controller 310 acquires information about the found position and orientation. The controller 310 controls the robot arm 300 by sending a drive command to the robot arm 300 based on the information (measurement result) about their position and orientation. The robot arm 300 holds the object to be detected 210 with a robot hand (gripping unit) or the like which is located at the tip thereof to move the object to be detected 210 translationally, rotationally, or the like. Furthermore, an article composed of a plurality of parts, such as an electronic circuit substrate and machine can be manufactured by installing (assembling) the object to be detected 210 in another part by using the robot arm 300. In addition, an article can be manufactured by processing the moved object to be detected 210. The controller 310 has a calculating unit such as a CPU and a storage unit such as a memory. Also, a controller for controlling a robot may be provided outside the controller 310. In addition, a display unit 320 (such as display) may display measurement data obtained by measurement with the measuring apparatus 100, the obtained image, or the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-095182, filed May 11, 2016, which is hereby incorporated by reference wherein in its entirety.

What is claimed is:

1. A holding apparatus for holding an optical element, the apparatus comprising:
a positioning member configured to position the optical element; and
an elastic member configured to apply a biasing force to the optical element toward the positioning member,
wherein the positioning member and the elastic member are configured such that a difference between a linear expansion amount of the elastic member and a linear expansion amount of the optical element in a direction crossing a direction of the biasing force is not greater than a threshold.

2. The holding apparatus according to claim 1,
wherein the positioning member and the elastic member are configured such that a direction of the biasing force matches a direction of expansion of the optical element at a point where the biasing force acts on the optical element.

3. The holding apparatus according to claim 1,
wherein the elastic member is fixed to the positioning member.

4. The holding apparatus according to claim 3,
wherein the elastic member is fixed at such a position on the positioning member that the difference is not greater than the threshold.

5. The holding apparatus according to claim 1, further comprising a first adjusting member configured to adjust a position of a point on the optical element where the biasing force acts.

6. The holding apparatus according to claim 1, further comprising a second adjusting member disposed between the optical element and the positioning member such that a direction of expansion of the optical element at a point on the optical element where the biasing force acts matches a direction of the biasing force.

7. The holding apparatus according to claim 1,
wherein the elastic member includes a plate spring or a compression spring.

8. A measurement apparatus that comprises an optical element and performs measurement of an object by projecting a pattern onto the object via the optical element and imaging the object on which the pattern is projected, the apparatus comprising:
a holding apparatus, defined in claim 1, for holding the optical element.

9. A system comprising:
a measurement apparatus defined in claim 8; and
a robot configured to perform movement of the object for which measurement has been performed by the measurement apparatus.

10. A method of manufacturing an article, the method comprising steps of:
performing movement of an object, for which measurement has been performed by a measurement apparatus, by a robot; and
processing the object, of which the movement has been performed, to manufacture the article,
wherein the measurement apparatus includes an optical element and performs measurement of the object by projecting a pattern onto the object via the optical element and imaging the object on which the pattern is projected, the apparatus including:
a holding apparatus for holding the optical element, the holding apparatus including:
a positioning member configured to position the optical element; and
an elastic member configured to apply a biasing force to the optical element toward the positioning member,
wherein the positioning member and the elastic member are configured such that a difference between a linear expansion amount of the elastic member and a linear expansion amount of the optical element in a direction crossing a direction of the biasing force is not greater than a threshold.
